(19) United States
(12) Patent Application Publication
(10) Pub. No.: US 2006/0044223 A1
(43) Pub. Date: Mar. 2, 2006

(54) Plasma display device and driving method thereof

(76) Inventors: Jin-Ho Yang, Suwon-si (KR); Woo-Joon Chung, Suwon-si (KR); Tae-Seong Kim, Suwon-si (KR)

Correspondence Address: CHRISTIE, PARKER & HALE, LLP, PO BOX 7068, PASADENA, CA, 91109-7068, US

(21) Appl. No.: 11/192,531

(22) Filed: Jul. 29, 2005

(30) Foreign Application Priority Data
Sep. 1, 2004 (KR) 10-2004-0069494

(51) Int. Cl. G09G 3/28

(52) U.S. Cl. 345/60

(57) ABSTRACT

A plasma display panel. Delay circuits are added to a control terminal of a switch and a rising delay time is established to be different from a falling delay time in an address driving circuit so that voltages at adjacent address electrode may not be concurrently changed in the opposite directions. Accordingly, power consumption by the address driving circuit is minimized without a power recovery circuit.

### CROSS-REFERENCE TO RELATED APPLICATION

This application claims priority to and the benefit of Korean Patent Application No. 10-2004-0069494 filed in the Korean Intellectual Property Office on Sep. 1, 2004, the entire content of which is incorporated herein by reference.

### FIELD OF THE INVENTION

The present invention relates to a plasma display device, and in particular, to an address driving circuit of a plasma display device.

### BACKGROUND OF THE INVENTION

Plasma display panels are flat panel displays that use plasma generated by gas discharge to display characters or images. The plasma display panels include, according to their size, more than several tens to millions of pixels arranged in the form of a matrix. These plasma display panels are classified into a direct current (DC) type and an alternating current (AC) type according to patterns of waveforms of driving voltages applied thereto and discharge cell structures thereof.

A typical AC plasma display panel has scan electrodes and sustain electrodes in parallel on one side thereof, and has address electrodes crossing the scan electrodes and sustain electrodes on another side thereof. The sustain electrodes are formed to correspond to the respective scan electrodes, and one terminal of each of the sustain electrodes is coupled in common to those of the scan electrodes.

In general, a method for driving the AC plasma display panel can be expressed by temporal operation periods, i.e., a reset period, an address period, and a sustain period. The reset period is a period to reset the state of each cell such that an addressing operation of each cell is smoothly performed. The address period is a period to apply an address voltage to an addressed cell to accumulate wall charges on the addressed cell to in order to select a cell to be turned on and a cell not to be turned on in the PDP. The sustain period is a period to apply sustain discharge voltage pulses to the addressed cell, thereby performing a discharge according to which a picture is actually displayed.

In general, when a scan voltage is sequentially applied to the scan electrodes, an address voltage Va is applied to an address electrode passing through a discharge cell which will emit light, and a non-address voltage (0V generally) is applied to an address electrode passing through a discharge cell which will not emit light from among discharge cells formed at the scan electrodes to which the scan voltage is applied. The voltages Va and 0V are selectively applied to the address electrode when data are applied to the address electrode through an address driving IC, and the data are concurrently applied to the address electrode when the address driving IC applies the data Va and 0V to the address electrode. In this instance, the voltage applied to the address electrode is maintained at 0V, is maintained at the voltage Va, is changed from 0V to the voltage Va, or is changed from the voltage Va to 0V. When the voltage is changed from 0V to the voltage Va or is changed from the voltage Va to 0V in the above-noted four states, and in particular, when a voltage at one of adjacent address electrodes is changed from 0V to the voltage Va and the voltage at another one thereof is changed from the voltage Va to 0V, power corresponding to that generated when the voltage is changed from 0V to 2Vs is lost because of capacitance formed between adjacent address electrodes, and the power loss is very large. Therefore, a power recovery circuit is conventionally used to reduce the power loss. However, when the voltage at one of adjacent address electrodes is changed from 0V to the voltage Va and the voltage at another one thereof is changed from the voltage Va to 0V, the voltages of the address electrodes need to be increased to the voltage Va from 0V and decreased the same again to 0V, or be decreased from the voltage Va to 0V and increased again the same to the voltage Va. Therefore, the voltages of address electrodes which need no data variation must concurrently be changed.

### SUMMARY OF THE INVENTION

In accordance with the present invention an address driving circuit is provided having the advantages of minimizing power consumption.

An exemplary plasma display device according to an embodiment of the present invention includes a panel and a plurality of selection circuits. The panel includes a plurality of first electrodes in a first direction and a plurality of second electrodes in a second direction crossing the first direction. The selection circuits include a first selection circuit and a second selection circuit respectively including a first transistor having a first terminal coupled to a first power source for supplying an address voltage and a second terminal coupled to the second electrode, and a second transistor having a first terminal coupled to the second electrode and a second terminal coupled to a second power source for supplying a non-address voltage. The first transistor applies the address voltage to a selected second electrode, and the second transistor applies the non-address voltage to a non-selected second electrode. The time when the first transistor of the first selection circuit is turned on is different from the time when the second transistor of the second selection circuit is turned on.

The plasma display device further includes a control circuit. The control circuit outputs a control signal for controlling turn-on/off operations of the first and second transistors according to an input signal. A delay time until the first transistor of the first selection circuit is turned on after the input signal is applied is different from a delay time until the second transistor of the second selection circuit is turned on after the input signal is applied. The control circuit includes an inverter and a first delay circuit. The inverter has an output terminal coupled to a control terminal of the second transistor. The first delay circuit has an input terminal for receiving the input signal, and an output terminal coupled in common to an input terminal of the inverter and a control terminal of the second transistor. A rising delay time of the first delay circuit is different from a falling delay time thereof.

In a further embodiment, a method is provided for driving a plasma display device having a plurality of first electrodes in a first direction and a plurality of second electrodes in a second direction crossing the first direction. A rising time of a rising address pulse is different from a falling time of a falling address pulse when the rising address pulse is applied to one of second electrodes and the falling address pulse is applied to another second electrode thereof.

### BRIEF DESCRIPTION OF THE DRAWINGS

FIG. 1 shows a plasma display device according to an embodiment of the present invention.

FIG. 2A and FIG. 2B shows waveform diagrams applied to an address electrode according to an embodiment of the present invention.

FIG. 3 shows an address driving circuit according to an embodiment of the present invention.

FIG. 4 shows a circuit diagram of an address selection circuit in an address driving circuit according to an embodiment of the present invention.

FIG. 5A shows an output waveform diagram of respective nodes when the ratio of rising delay time vs. falling delay time is given to be 1:2 in FIG. 4.

FIG. 5B shows an output waveform diagram of respective nodes when the ratio of rising delay time vs. falling delay time is given to be 2:1 in FIG. 4.

### DETAILED DESCRIPTION

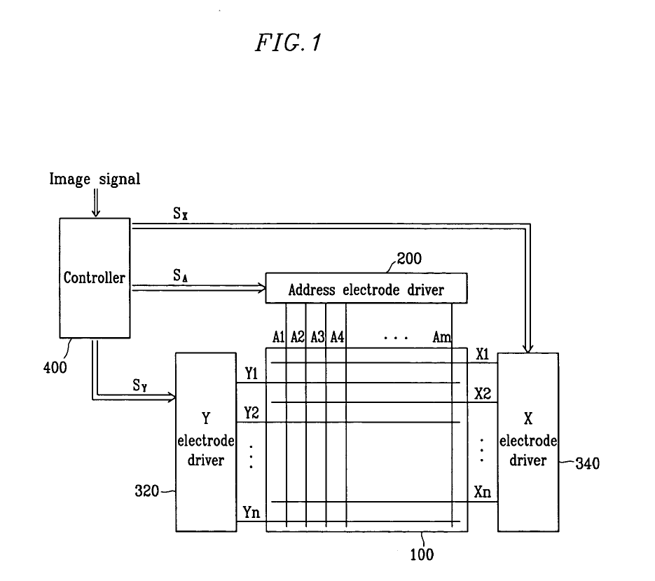

Referring to FIG. 1, a configuration of a plasma display device according to an embodiment of the present invention will now be described. The plasma display device includes a plasma display panel 100, an address electrode driver 200, a Y electrode driver 320, an X electrode driver 340, and a controller 400.

The plasma display panel 100 includes a plurality of address electrodes A1 to Am in a column direction, and first sustain electrodes Y1 to Yn and second sustain electrodes X1 to Xn in a row direction. The address electrode driver 200 receives an address driving control signal SA from the controller 400, and applies a display data signal for selecting a discharge cell to be displayed to the address electrodes. The Y electrode driver 320 and the X electrode driver 340 receive a Y electrode driving signal SY and an X electrode driving signal SX from the controller 400 and apply the same to the X electrode and the Y electrode, respectively. The controller 400 receives an external image signal, generates an address driving control signal SA, a Y electrode driving signal SY, and an X electrode driving signal SX, and transmits the same to the address electrode driver 200, the Y electrode driver 320, and the X electrode driver 340, respectively.

In general, a plasma display panel is driven by dividing a frame into a plurality of subfields, and a discharge cell to be discharged is selected from among a plurality of discharge cells in an address period of each subfield. In this instance, a scan voltage is sequentially applied to the scan electrodes, and scan electrodes to which no scan electrode is applied are biased with a positive voltage in order to select a discharge cell in the address period. An address voltage is applied to an address electrode passing through a discharge cell to be selected, and a non-address voltage is applied to an address electrode which is not selected from among discharge cells formed by the scan electrodes to which the scan voltage is applied. The address voltage and the non-address voltage respectively use a positive voltage and a ground voltage, and the scan voltage uses the ground voltage or a negative voltage so that the address electrode to which the address voltage is applied and the scan electrode to which the scan voltage is discharged and corresponding discharge cells are selected as light emitting cells.

An address driving circuit in the address electrode driver 200 will now be described in more detail. A concurrent voltage variation at adjacent address electrodes is prevented in order to minimize power consumption and efficiently charge/discharge capacitance between the electrodes when the voltages at the adjacent address electrodes are varied differently (e.g., to be increased or decreased.) That is, it is possible that the voltage at one address electrode rises and the voltage at another address electrode then falls, or the voltage at one address electrode falls and the voltage at another address electrode then rises.

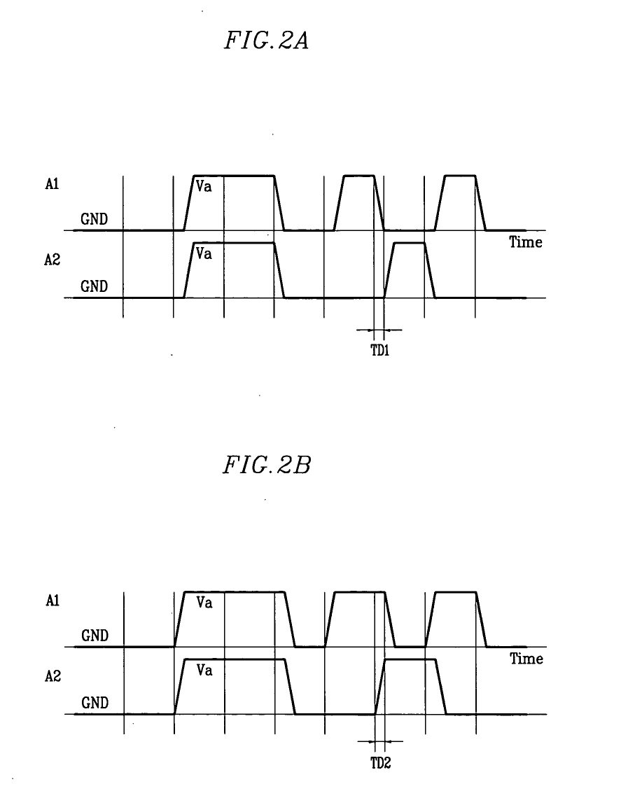

FIG. 2A and FIG. 2B show waveform diagrams applied to an address electrode according to an embodiment of the present invention. FIG. 2A shows the case in which the rising delay time TD1 is established to be longer than the falling delay time assuming that the falling delay time is given as 0. FIG. 2B shows the case in which the falling delay time TD2 is established to be longer than the rising delay time assuming that the rising delay time is given as 0. FIG. 3 shows an address driving circuit for applying the waveforms of FIG. 2A and FIG. 2B, according to an embodiment of the present invention.

As shown in FIG. 3, the address driving circuit includes a plurality of address selection circuits 220₁ to 220ₘ. The address selection circuits 220₁ to 220ₘ are respectively coupled to a plurality of address electrodes A₁ to Aₘ, and respectively include two driving and grounding switches A_{H} and A_{L}. Field effect transistors with body diodes are usable as the switches A_{H} and A_{L}, and other switches performing the same or similar functions are also applicable.

A first terminal of the driving switch A_{H} is coupled to a power source (voltage) Va for supplying an address voltage and a second terminal thereof is coupled to address electrodes A₁ to Aₘ of a panel capacitor Cp, and the address voltage Vₐ is transmitted to the address electrodes A₁ to Aₘ when the driving switch A_{H} is turned on. The grounding switch A_{L} is coupled between the address electrodes A₁ to Aₘ and the ground, and a ground voltage is transmitted to the address electrodes A₁ to Aₘ when the grounding switch A_{L} is turned on. The driving switch A_{H} and the grounding switch A_{L} are generally considered to be changing switches since they are not turned on concurrently.

As described, the switches A_{H} and A_{L} of the address selection circuits 220₁ to 220ₘ coupled to the address electrodes A₁ to Aₘ are turned on or off by a control signal, and the address voltage Va or the ground voltage is accordingly applied to the address electrodes A₁ to Aₘ. That is, the address electrode to which the address voltage Va is applied when the driving switch A_{H} is turned on in the address period is selected, and the address electrode to which the ground voltage is applied when the grounding switch A_{L} is turned on in the address period is not selected.

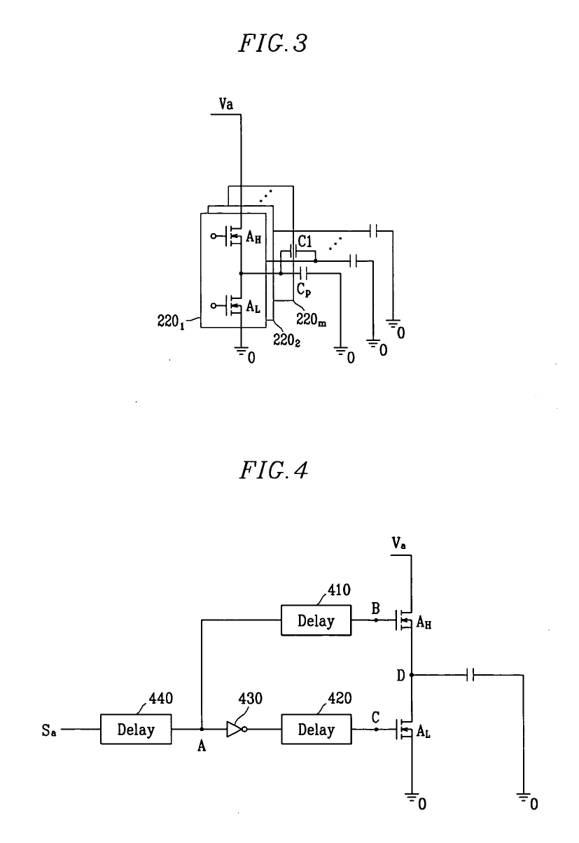

FIG. 4 shows a circuit diagram of an address selection circuit in an address driving circuit according to an embodiment of the present invention. FIG. 4 shows a single address selection circuit for ease of description.

As shown in FIG. 4, control terminals of the switch A_{H} and the switch A_{L} are coupled to delay circuits 410 and 420, and an inverter 430 is coupled to a first terminal of the delay circuit 420 coupled to the switch A_{L}. A delay circuit 440 is coupled between an input terminal of a signal Sa and a node of the inverter 430 and the delay circuit 410. Rising delay times of the delay circuits 410, 420, and 430 are established to be longer than falling delay times thereof in order to output the waveforms of FIG. 2A.

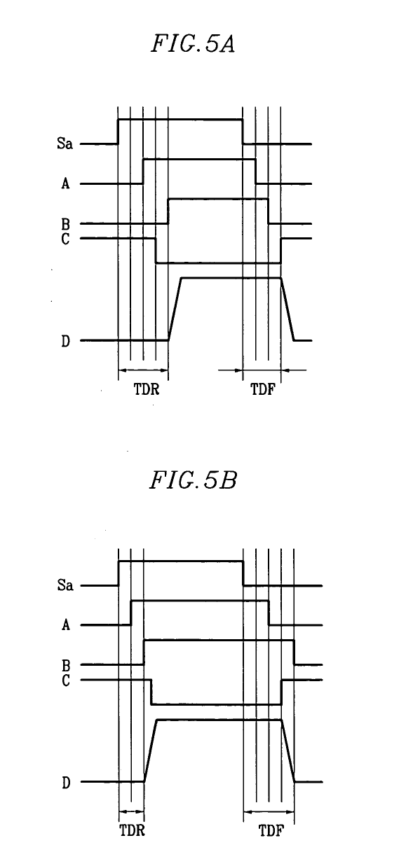

FIG. 5A shows an output waveform diagram of respective nodes when the ratio of rising delay time TDR vs. falling delay time TDF is given to be 2:1 in FIG. 4. As shown in FIG. 5A, the delay circuit 440 outputs a signal A with a rising edge delayed by two steps, and a falling edge delayed by one step when the signal Sa is input. The delay circuit 410 receives the signal A and outputs a signal B with a rising edge delayed by two steps and a falling edge delayed by one step. The inverter 430 inverts the signal A, and the delay circuit 420 receives the inverted signal A and outputs a signal C with a rising edge (i.e., the inverted falling edge) delayed by two steps and a falling edge (i.e., the inverted rising edge) delayed by one step. The switch A_{H} is turned on when the signal B is High, the switch A_{L} is turned on when the signal C is High, the voltage Va is applied to the address electrode when the switch A_{H} is turned on, and the ground voltage is applied thereto when the switch A_{L} is turned on.

Accordingly, the switch A_{H} is turned on when the rising edge of the signal Sa is delayed by four steps, the switch A_{L} is turned on when falling edge of the signal Sa is delayed by three steps, and a signal D is applied to the address electrode. Falling delay times of the delay circuits 410, 420, and 440 are established to be longer than rising delay times thereof in order to output the waveforms of FIG. 2B.

FIG. 5B shows an output waveform diagram of respective nodes when the ratio of rising delay time TDR vs. falling delay time TDF is given to be 1:2 in FIG. 4.

As shown in FIG. 5B, the delay circuit 440 outputs a signal A with a falling edge delayed by two steps and a rising edge delayed by one step when the signal Sa is input. The delay circuit 410 receives the signal A and outputs a signal B with a falling edge delayed by two steps and a rising edge delayed by one step. The inverter 430 inverts the signal A, and the delay circuit 420 receives the inverted signal A and outputs a signal C with a falling edge delayed by two steps and a rising edge delayed by one step. Accordingly, the switch A_{H} is turned on when the rising edge of the signal Sa is delayed by two steps, the switch A_{L} is turned on when falling edge of the signal Sa is delayed by four steps, and a signal D is applied to the address electrode.

An efficiency of power consumption according to an embodiment of the present invention will now be described.

As shown in FIG. 3, power loss generated when the voltages at adjacent address electrodes are changed in the opposite direction is given as ½*C1*(2Va²)+2*(½*C2*Va²)=(2C1+C2)*Va² when it is defined that the capacitance formed between the adjacent address electrode A1 and the address electrode A2 is C1 and the capacitance between the address electrode A1, the address electrode A2, and other electrodes (an X electrode and a Y electrode) is C2 (which corresponds to Cp in FIG. 3). However, the power loss generated when the voltage falls and then rises or the same rises and then falls according to an embodiment of the present invention is given as 2*(½*C1*Va²)+2(½*C2*Va²)=(C1+C2)*Va². Accordingly, the power loss is reduced as compared to the case in which voltages at two adjacent address electrodes are concurrently changed.

Three delay circuits are provided between the control terminal of the switches A_{H} and A_{L} and the input terminal of the signal Sa as described above, and in addition, it is possible to couple a single delay circuit having the respective delay circuits integrated to the input terminal of the signal Sa without adding the delay circuits to the control terminal of the switches A_{H} and A_{L} according to another embodiment of the present invention.

According to the present invention, concurrent changes of voltages at adjacent address electrodes in the opposite directions are prevented by adding delay circuits to the control terminal of switches and differentiating the rising delay and the falling delay in the address driving circuit. Therefore, power consumption by the address driving circuit is minimized without application of a power recovery circuit.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A plasma display device comprising:
a panel including a plurality of first electrodes in a first direction and a plurality of second electrodes in a second direction crossing the first direction; and
a plurality of selection circuits including a first selection circuit and a second selection circuit respectively including a first transistor having a first terminal coupled to a first power source for supplying an address voltage and a second terminal coupled to the second electrode, and a second transistor having a first terminal coupled to the second electrode and a second terminal coupled to a second power source for supplying a non-address voltage, the first transistor applying the address voltage to a selected second electrode, and the second transistor applying the non-address voltage to a non-selected second electrode,
wherein the time when the first transistor of the first selection circuit is turned on is different from the time when the second transistor of the second selection circuit is turned on.

2. The plasma display device of claim 1, wherein the plasma display device further comprises a control circuit for outputting a control signal for controlling turn-on/off operations of the first and second transistors according to an input signal, and
a delay time until the first transistor of the first selection circuit is turned on after the input signal is applied is different from a delay time until the second transistor of the second selection circuit is turned on after the input signal is applied.

3. The plasma display device of claim 1, wherein the control circuit comprises:
an inverter having an output terminal coupled to a control terminal of the second transistor; and
a first delay circuit having an input terminal for receiving the input signal, and an output terminal coupled in common to an input terminal of the inverter and a control terminal of the second transistor,
wherein a rising delay time of the first delay circuit is different from a falling delay time thereof.

4. The plasma display device of claim 3, wherein the control circuit further comprises:
a second delay circuit coupled between the output terminal of the first delay circuit and the control terminal of the first transistor; and
a third delay circuit coupled between the output terminal of the inverter and the control terminal of the second transistor, and
wherein rising delay times and falling delay times of the second and third delay circuits are different.

5. The plasma display device of claim 1, wherein a voltage at one second electrode is changed to the non-address voltage and a voltage at another second electrode then starts being changed when the voltage at one second electrode is changed from the address voltage to the non-address voltage and the voltage at another second electrode is changed from the non-address voltage to the address voltage.

6. The plasma display device of claim 1, wherein a voltage at another second electrode is changed to the address voltage and a voltage at one second electrode then starts being changed when the voltage at one second electrode is changed from the address voltage to the non-address voltage and the voltage at another second electrode is changed from the non-address voltage to the address voltage.

7. A method for driving a plasma display device including a plurality of first electrodes in a first direction and a plurality of second electrodes in a second direction crossing the first direction, wherein a rising time of a rising address pulse is different to a falling time of a falling address pulse when the rising address pulse is applied to one of second electrodes and the falling address pulse is applied to another second electrode thereof.

8. The method of claim 7, wherein a time for the address pulse to rise after a control signal for applying the rising address pulse is different from a time for the address pulse to fall after a control signal for applying the falling address pulse.
